(19) United States
(12) Patent Application Publication
(10) Pub. No.: US 2019/0215477 A1
(43) Pub. Date: Jul. 11, 2019

(54) SCREEN BLOCKING APPARATUS AND METHOD OF USE

(71) Applicant: Richard Rudolph Pisani, Spokane, WA (US)

(72) Inventor: Richard Rudolph Pisani, Spokane, WA (US)

(21) Appl. No.: 16/240,730

(22) Filed: Jan. 5, 2019

Related U.S. Application Data
(60) Provisional application No. 62/613,828, filed on Jan. 5, 2018.

(51) Int. Cl. H04N 5/64; A44B 11/00; A44B 11/02

(52) U.S. Cl. CPC H04N 5/64; H04N 7/002; A44B 11/02; A44B 11/005

(57) ABSTRACT

A removable, adjustable strap that secures around a television screen when a sports ticker is present and blocks the ticker from being visible on the screen.

### BACKGROUND

### 1. Field of the Invention

The present invention relates generally to television screen systems, and more specifically, to a strap apparatus that obscures part of the screen for conveniently blocking parts of the television screen.

### 2. Description of Related Art

Television screen systems are well known in the art and are effective means to view the display of a television. For example, FIG. 1 depicts a conventional television set system 101 having a box 103, and a screen 105. During use, signals are received in the box 103 and then the signals are displayed on the screen 105. Users can manipulate the channels in the box 103 and the display on the screen 105 corresponds to the change. A sports ticker 107 can appear on the screen 105. The sports ticker 107 usually appears at the bottom of the screen 105, but it can appear at other locations.

One of the problems commonly associated with system 101 is users may see unwanted images or tickers on the screen. For example, a user may see unwanted sports tickers 107 or other informational tickers at the bottom of the screen 105 that distract from the television program. Users watching athletic games frequently do not like having the sports ticker 107 at the bottom of the screen because it displays scores for games they stored, recorded, or have yet to watch, thus ruining the future game.

Accordingly, although great strides have been made in the area of television screens, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a front view of a common conventional television system;

FIG. 2A is a front view of a television screen with the device attached to the television in accordance with a preferred embodiment of the present application;

FIG. 2B is a front view of a television screen with the device detached from the screen;

FIG. 3 is a front view of the device's strap;

FIG. 4 is a front view of the device's buckle;

FIG. 4A is a front vies of the device's buckle with the strap removed for clarity; and

FIG. 5 is a flowchart depicting the preferred method of use.

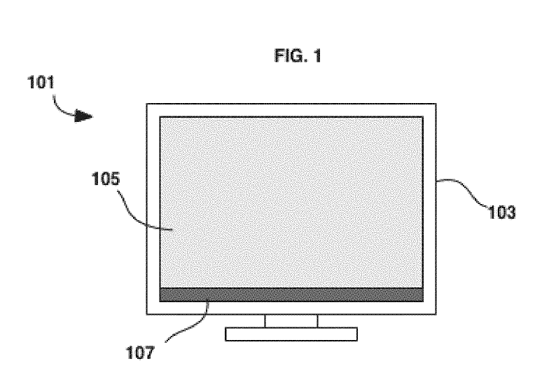

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional television screen systems. Specifically, the apparatus allows the user to block the bottom of the screen while the blocking device is secured at the back of the television. The strap ensures that the blocker stays in the desired location, and the user does not need to readjust the blocker while in use. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

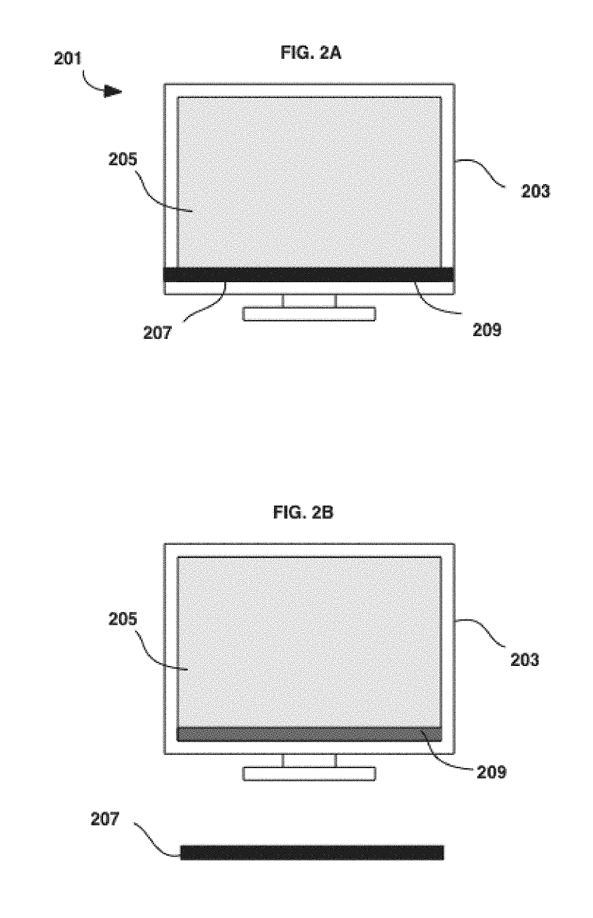

Referring now to the drawings wherein like reference characters identify corresponding or similar elements throughout the several views, FIGS. 2A and 2B depict front views of a television screen system 201 with the blocking strap 207 removably attached in accordance with a preferred embodiment of the present application. It will be appreciated that strap 207 overcomes one or more of the above-listed problems commonly associated with conventional television systems.

In the contemplated embodiment, system 201 includes a television screen 205, a television back 203, a blocking strap 207, and a sports ticker 209. The blocking strap 207 is placed along a desired location on the screen 205 where the sports ticker 209 is visible, thereby being configured to block that portion of the screen. The preferred embodiment of the screen 205 is a television screen, but it is contemplated that any digital screen such as a computer screen, a tablet screen, or a phone screen can be used. The blocking strap 207 secures behind the television back 203, thereby blocking the sports ticker 209. The preferred embodiment is that the blocking strap 207 secures through a single, adjustable buckle behind the television, however it is contemplated that the blocking strap 207 can also be secured by snapping, hook and loop securement, tying, or the like.

The material of the blocking strap 207 is configured to be comprised of material such as polyester, nylon, or the like. The strap 207 is configured to be adjustable so the apparatus is secured over the desired part of the screen 205, but can be adjusted as to not damage the screen 205. Further, the adjustability allows for a single strap to be used on multiple sized televisions.

FIG. 2B depicts a television with the blocking strap 207 detached from the screen 205 and is shown for clarity, wherein sports ticker 209 is thereby visible to the user.

It should be appreciated that one of the unique features believed characteristic of the present application is that part of a television screen can be blocked, and done so in a reliable way without risking damage to the screen or television.

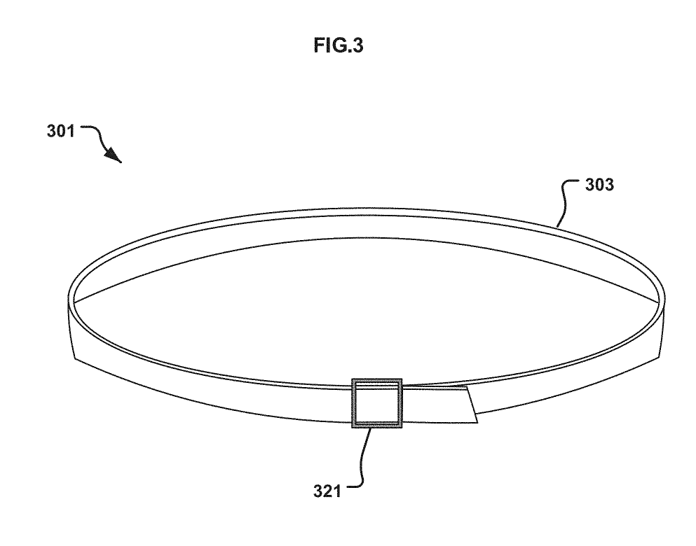

Referring now to FIG. 3 where a back oblique view of the strap 207 is shown. The blocking strap 207 wraps around the screen 205 (shown in FIG. 2) and secures through the strap's buckle 305. The blocking strap 207 loops through the buckle 305 and the user pulls the strap 305 until the strap is secured at a desired size. The buckle 305 allows the for the strap 207 to be tightened or loosened depending on the size of the screen 205. It should be appreciated that the preferred embodiment uses a ring style buckle, as shown in FIG. 3, such as a tri-glide buckle, however, it should be appreciated that adjustability could be accomplished via a single strap, being composed of an elastic material, thereby allowing for the user to stretch the strap to secure to the television. Further, other means of adjustability, such as hook and loop fasteners could replace the ring style buckle.

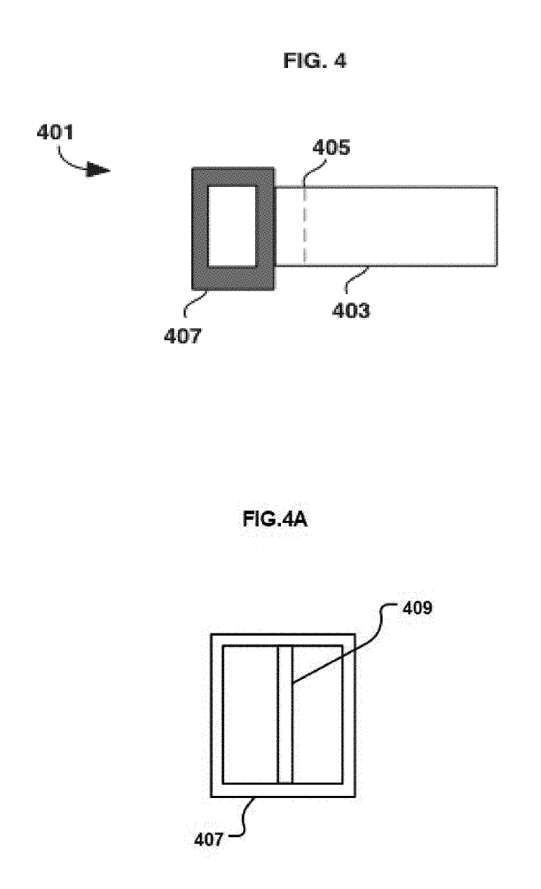

Referring now to FIGS. 4 and 4A where a front view of the strap's buckle is shown. A piece of the end strap 403 loops through the buckle 407. The preferred embodiment for the buckle is an appropriate size to receive a strap with a two inch width, but it is contemplated that other sizes may be used for different sized screens or straps. The preferred material for the buckle 407 is plastic, but it is contemplated that other materials such as wood, foam, or metal may also be used.

In FIG. 4A, a front view of the buckle 407 is shown with the strap removed for clarity. The buckle 407 contains a middle piece 409 that the end strap 403 loops around and is then secured to the rest of the end strap 403 by a securement 405. The preferred embodiment for the securement 405 is by sewing or stitching the pieces of the strap together, but alternative embodiments are contemplated to include gluing, tying, or the like. The preferred embodiment is that once the end strap is secured through the securement 405, the user will then take the other end piece of the strap (not shown), loop it through the buckle 407, and pull the strap until the strap is secure around the screen. The looping of the strap through the buckle 407 allows the device to be removed from the screen if desired, and also for the device to be freely adjusted by the user.

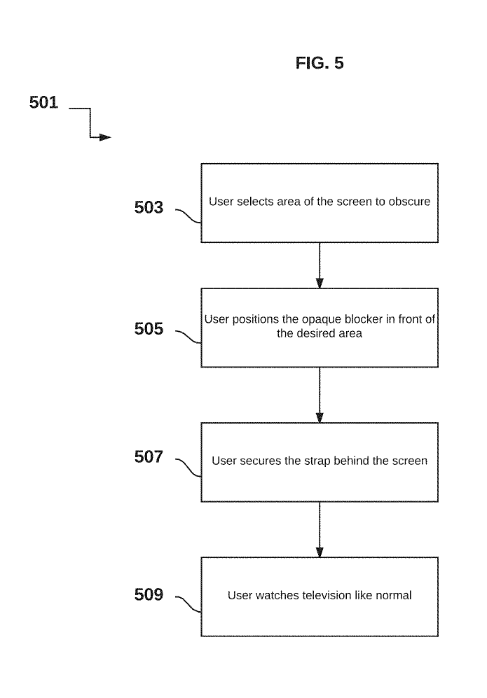

Referring now to FIG. 5 where a flowchart depicting the preferred method of use is shown. The user selects a part of the screen he or she wishes to block and secures the opaque part of the apparatus over the area, as shown in boxes 503 and 505. The user then uses the straps and securing devices to secure the blocker in front of the screen, as shown in box 507. The preferred embodiment is that the strap secures through a buckle, but it is contemplated that the strap can be secured by means such as hook and loop securement, snaps, buttons, or the like. The user finally watches television like normal, except with the unwanted part of the screen obscured, as shown in box 509.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A system for concealing a sports ticker, the system comprising:
a television having a screen configured to display the sports ticker;
a strap apparatus configured to removably secure around a portion of the screen, thereby blocking the portion of the screen from being visible, the strap having:
a buckle device configured to provide a means of adjusting a fit of the strap around the television.

2. The system of claim 1, wherein the strap is composed primarily of a woven cotton-nylon material.

3. The system of claim 1, wherein the buckle device is a ring buckle configured to allow sliding adjustment of the strap.

4. The system of claim 1, wherein the strap is composed of an elastic material.

5. A method of blocking a portion of a television screen, the method comprising:
providing a television, the television having a screen;
providing a strap apparatus having an adjustability device configured to adjust a diameter of the strap apparatus;
loosening the adjustability device to allow the strap apparatus to open to a large diameter;
placing the strap apparatus around the television, wherein the strap apparatus is positioned to block the portion of the television screen; and
tightening the adjustability device to secure the strap apparatus in place.

6. The method of claim 5, wherein the strap apparatus is composed of a woven cotton-nylon material.

7. The method of claim 5, wherein the adjustability device is a ring buckle.

8. The method of claim 5, wherein the strap apparatus is composed of an elastic material.
